(19) United States
(12) Patent Application Publication
(10) Pub. No.: US 2019/0370672 A1
(43) Pub. Date: Dec. 5, 2019

(54) COMPUTERIZED INTELLIGENT ASSESSMENT SYSTEMS AND METHODS

(71) Applicant: Ashley Jean Funderburk, San Francisco, CA (US)

(72) Inventor: Ashley Jean Funderburk, San Francisco, CA (US)

(21) Appl. No.: 15/992,193

(22) Filed: May 30, 2018

(51) Int. Cl. G06N 5/04; G09B 7/00; G06F 17/30

(52) U.S. Cl. CPC G06N 5/04; G06F 17/30699; G09B 7/00

(57) ABSTRACT

A computerized intelligent assessment system for use in intelligently assessing responses to questions as work entries. The system includes a reasoning methods module for determining reasoning methods in problem solving responses for degrees of work sophistication. Also, the reasoning methods module includes a response correctness and diagnosing module for understanding work response correctness and for diagnosing the problem-solving work response strategies of subcategories for the problem-type strands. An analysis module further included in the reasoning methods module analyzes the work responses, determines the reasoning method, and generates recommendations. A stroke clustering module for analyzes digital strokes in a scratch area, clusters and assigns strokes to logically coherent clusters, and classifies a cluster type as numeric expressions or drawings. The system further includes a stroke feature extraction and text feature extraction module for determining work features from logical representation of text or graphical expressions.

### CROSS-REFERENCE TO RELATED APPLICATIONS

This application claims the benefit of co-pending U.S. Utility application Ser. No. 15/009,302, filed on Jan. 28, 2016, which claimed the benefit of co-pending U.S. Provisional Application Ser. No. 62/254,043, filed on Nov. 11, 2015. The disclosures of the prior applications are considered to be part of, and are incorporated by reference in, the disclosure of this application.

### COPYRIGHTABLE SUBJECT MATTER

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

### 1. Field of the Invention

This invention relates generally to teaching aids, and more particularly to computerized intelligent assessment systems and methods.

### 2. General Background and State of the Art

Long-term studies of teaching support the notion that teachers' knowledge of students' reasoning can have a positive influence on the teaching and learning of students who are marginalized in schools. In addition, government practice guides suggest the more students reflect on their problem-solving processes, the better their reasoning and their ability to apply this reasoning to new situations will be.

Further, they suggest when teaching students about an abstract principle or skill, such as a mathematical function, teachers should connect abstract ideas to relevant concrete representations and situations, making sure to highlight the relevant features across all forms of the representation of the function. Connecting different forms of representations helps students master the concept being taught and improves the likelihood that students will use it appropriately across a range of different contexts.

For example, an abstract idea, like a mathematical function, can be expressed in many different ways: Concisely in mathematical symbols like “y=2·x”; visually in a line graph that starts at 0 and goes by 2 units for every 1 unit over; discretely in a table showing that 0 goes to 0, 1 goes to 2, 2 goes to 4, and so on; practically in a real world scenario like making $2 for every mile you walk in a walkathon; and physically by walking at 2 miles per hour. By showing students the same idea in different forms, teachers can demonstrate that although the “surface” form may vary, it is the “deep” structure—what does not change—that is the essence of the idea.

In a different discipline, another technique involves connecting or “anchoring” new ideas in stories or problem scenarios that are interesting and familiar to students. Thus, students not only have more motivation to learn, but have a strong base on which to build the new idea and on which to return later if they forget.

However, the developers of published curriculums recognized that teachers, in a curriculum such as mathematics, tend to skip teaching informal mathematics and go straight to teaching formal mathematics. Progressive formulization has been described as a progression of learning that begins with student's informal strategies and knowledge that develops into pre-formal methods that are still connected with concrete experiences, strategies and models. Then through guided reinvention the pre-formal models and strategies progressively develop into abstract and formal mathematical procedures, concepts, and insights.

Further, this comprehensive curriculum, as for example mathematics, has indicated that algorithms or formal mathematics procedures depend on prior understanding of informal and pre-formal mathematics procedures. Thus, an effective teacher needs to be sensitive to the information that students already have and to connect new information to it.

Further, when teaching a subject, including traditional subjects such as, for example, all mathematics, all science, composition, and English, including grammar, spelling, and content development, an effective teacher needs to be able to navigate student's thinking and understanding within the teaching subject terrain. However. the question is how can one navigate without knowing where one is headed? Being able to clarify student understanding is only possible when the teacher can see where the student is having trouble. Therefore, teachers need to have the ability to draw out and discern students' reasoning.

By contrast, it has been pointed out that explicit connections between abstract concepts and their concrete representations are not always made in textbooks, nor in instructional materials prepared to support teachers. And even when they do, many of the curricula do not properly teach different methods of reasoning, or do not teach the necessary progression of methods of increasing sophistication.

Since there are limited assessment materials available to support teacher's ability to elicit and discern student's reasoning of teaching subjects, it is proposed to have a theory-driven and classroom-based itechnology which will provide teachers with the knowledge to understand (draw out, analysis, interpret and categorize) student reasoning and recommend the proper interventions to teach them the different method(s) necessary for proficiency, building on each student's current level of knowledge

One of the main challenges for teaching progressive formulization is to convince the teachers who are resistant to a different teaching approach, which has been ingrained in the U.S. education system. The instrument(s) methods herein can be a catalyst for the underlying philosophy of the current reform curriculum, and thus can enable a new curriculum to be developed for mainstream educators.

For example, regarding the teaching subject of mathematics, a good proportion of students who currently have a grade letter of A in their mathematics course (such as algebra) are not at the formal level of reasoning. Given that mathematics and algebra are a hierarchy because each successive level depends on the preceding one, these students who are progressing to the next level may be gaining a fallacious progression along the hierarchy of mathematics-algebra. By allowing those students with passing grades who may have knowledge but are not at the formal level of reasoning, educators may be decreasing their probability of eventually achieving full progression along the hierarchy of mathematics-algebra. Thus there is a need for teachers to grade not only on correctness (e.g. correct/incorrect answers) and/or knowledge (e.g. partial credit), but also on student reasoning. The system herein would assist teachers in determining what their students' true grades are.

Since math is a hierarchy, and, like math, standards build on one another (e.g. earlier grade level standards are needed to know upper grade level standards), different standards can be also be sequenced across different subject domains and/or across different subject domain strands. For example, geometry and algebra known as geogebra. Further, math standards such as volume can be used as anchor standards for learning other subjects like science.

Standardized tests test both mathematics and English language arts (literacy of reading and writing) where content doesn't just include mathematics standards and literacy of being able to read and write mathematics, but also includes history/social studies, sciences, technical studies and the arts. Such reading standards can ask students to answer questions dependent from the text read, and thus students can reason differently and at different levels about the questions.

Evidence based writing can demonstrate students' reasoning about what they read by inferences (circumstantial level of reasoning). Other types of evidence demonstrate only exactly what is in the questions' text (manipulative level or reasoning grounded in concrete text-evidence). Further, different forms of writing can be shown to draw solely from student experience and opinion (narrative voice of reasoning like counting on your fingers), yet other forms of writing can build knowledge through text and be independent from the texts itself detailing by sequence which conveys argumentative reasoning (symbolic reasoning).

The way in which teachers conceptualize assessing students' progress has a strong influence on their instructional decisions. Therefore, it is desirable to foster and contribute to the discussion that presses researchers and teacher educators to think more deeply about how teachers teaching a subject such as mathematics assess their students. Because teachers' ability to analyze student work needs to go beyond locating errors in calculation, the development, analysis and interpretation through the computerized intelligent assessment system herein describe students' reasoning, such as algebraic reasoning, wherein teachers need to know students' thinking, is set forth herein.

Unlike most classroom assessments, a feature is that the item responses in the computerized intelligent assessment system herein correspond to a model of student cognitive development for the concepts being measured, thus facilitating determinations about student's reasoning, such as algebraic reasoning. Each response to the items corresponds to different developmental levels of reasoning as ranges of progressive formulization from informal to formal mathematics. This system can be used by teachers when addressing the instructional needs of students who are grounded as concrete learners or those students who struggle with abstract (more formal) mathematics.

The Common Core State Standards (CCSS) Initiative has mandated a set of common standards in mathematics for education providers K-12 in states across the nation.

Most Common Core Mathematics standards expect students to use particular reasoning methods. For example: 4.NF.A.2 “Compare two fractions with different numerators and different denominators, e.g., by creating common denominators or numerators, or by comparing a benchmark fraction such as ½.”

Therefore, there has been identified a need for computerized intelligent assessment systems and methods as teaching aids.

### INVENTION SUMMARY

Briefly, and in general terms, in accordance with aspects of the invention, in a preferred embodiment, by way of example, there are provided system and methods for computerized intelligent assessment of student responses to test questions, for measurement of student's reasoning in a subject comprising a teaching subject, such as a traditional subject as, for example, mathematics, all science, all social studies, all computer sciences, technology, composition, and language such as English, including grammar, spelling, and content development.

An aspect of the system includes a rubrics for analyzing, interpreting and categorizing student's work of item responses to determine their reasoning methods and reasoning levels as a teaching subject assessment tool to provide feedback for instructional design.

A system of formative assessment prompts integrates different types of knowledge and places different cognitive demands on students.

Items that contain a correct/incorrect answer prompt (multiple choice selection or short answer field) elicits students' declarative knowledge (factual, conceptual knowledge) or “knowing that” knowledge.

Items that provide an area for scratch work (e.g. freehand strokes or digital strokes) and prompt students to “Show Your Work” elicits students' procedural knowledge (step-by-step or condition-action) or “knowing how” to do something;

Items that contain multiple blank lines or a long text field and prompt students to “Explain why” elicits students' schematic knowledge (knowledge used to reason about, predict, and explain things in nature) or “knowing why.”

The system can be used for student work for all possible item types, as described above, including but not limited to selected response, constructed response, extended response, technology enhanced, and performance tasks.

The system can used for scoring student work of items from any subject domain, including, but not limited to, mathematics, all science, all languages, all social studies, etc

The system enables computerized intelligent assessment of student work of items from any subject domain strand, including but not limited to Operations and Algebraic Thinking, Numbers and Operations in Base Ten, Number and Operations Fractions, Measurement and Data, Geometry, The Number System, Expressions and Equations, Functions, Statistics and Probability, The Real Number System, Quantities, The Complex Number System, Vector and Matrix Quantities, Arithmetic with Polynomials and Rational Expressions, Creating Equations, Linear Quadratic and Exponential Models, Trigonometric Functions, Interpreting Categorical and Quantitative Data, etc.

The system further determines student work of items from any subject domain strand's standards, including but not limited to, generating patterns, multiplying decimals, adding fractions, subtracting fractions, comparing fractions, mix numbers, recognizing volume as ab attribute of solid figures, volume measurement, finding area, finding perimeter, counting, interpret products of whole numbers, determine an unknown whole number in multiplication or division equations relating to three whole numbers, congruent figures, etc.

The system enables scoring of student work for a single item or any form of a collection of items organized as homework, quizzes, formative test and summative tests, standardized tests.

The system's rubrics can analyze interpret and categorize any item in any form from any source. Examples include but are not limited to any published textbook item, any online items, any district curriculums items, any supplemental textbooks and/or guides items, any teacher authored or created items, any item found on the Internet, any item from any educational technology's item pool, any standardize tests item.

Further examples include all item level difficulties, for example but not limited to item level difficulty 1, item level difficulty 2, item level difficulty 3, item level difficulty 4 etc. Also, examples include all item format level difficulties, for example but not limited to item format level difficulty 1, item format level difficulty 2, item format level difficulty 3, item format level difficulty 4 etc. Still further examples include any item testing any depth of knowledge.

The system observes evidence of work which consists of the student's answer which includes: the item (“question”), student's answer (“answer”), student's short and/or long explanation (“text”), and student's graphical scratch work (“strokes” or “show your work”). The system observes evidence including work and lack of work. Reasoning methods can be a correct method to solve an item or reasoning methods can be wrong methods to solve an item such as adding numerators and denominators of fractions with like denominators is a wrong method because you are only supposed to add the numerators. These wrong methods can be considered misconceptions.

The system recognizes features in student's strokes. For example, work might contain “5110” and thus one stroke feature extracted would be “Has Fraction”, another would be “Has Fraction with two digit denominator”. Also, the system recognizes features in student's text, for example, a student's text explanation might contain “I multiplied the length times the width” and thus one text feature extracted would be “Has Multiplication”.

The system, for example, uses combinations of features when scoring student's method(s) of reasoning and reasoning level(s). The system's combination of features, for example, contain features and lack of features.

The system recognizes question features. For example, a question feature might contain the items: number difficulty, format difficulty, standard, answer type. The system observes question features when scoring student's methods of reasoning and reasoning levels. The system recognizes answer features. For example, an answer feature might consider whether the item's answer was correct or incorrect, the answer was greater than the number 10, the answer does not equal the number 3/10. The system observes answer features when scoring student's methods of reasoning and reasoning levels.

The system observes evidence of student's work as demonstrating only one reasoning method and reasoning level or it observes evidence of multiple reasoning methods and reasoning levels for one item response.

The system has a method for determining which reasoning method(s) and reasoning level(s) that were demonstrated in the work meet the item's corresponding standard.

The system contains rubrics that can be very fine grained (e.g. item-specific rubrics) to fine grained (strand-specific rubrics) to coarse grained (subject-specific rubrics).

Another aspect is that the system is capable of being used as a method to create item-specific rubrics for analyzing, interpreting and categorizing students' work as reasoning methods at different levels of reasoning.

The system herein contains standard-specific rubrics for analyzing, interpreting and categorizing students' work as reasoning methods at different levels of reasoning.

Another aspect is that the system's methods are able to create strand-specific rubrics for analyzing, interpreting and categorizing students' work as reasoning methods at different levels of reasoning.

Another aspect is that the system's methods are able to create subject-specific rubrics for analyzing, interpreting and categorizing students' work as reasoning methods at different levels of reasoning. The system's methods are able to be used for formative or summative purposes.

The system's methods are capable of being used as a method of formative assessment, which takes place while instruction is still in progress to improve learning and teaching and has been shown to be particularly effective for students who have not done well in school, thus narrowing the gap between low and high achievers while raising overall achievement.

The system's methods are able to be used to analyze students' reasoning with respect to the learning goals, so that teachers can determine the gap between what students know and what they are expected to learn.

After student's work is assessed, it can be recorded in a report as the student's performance profile. The student's performance profile report can be used to determine what the next appropriate item should be administered to the student.

Further creating students' performance profiles that reports and keeps track of aggregated student scores can be used as more accurate way of assessing and measuring student's proficiency.

Further included is a method for utilizing a pattern of recognition to generate a performance profile to determine the next task in order to achieve conceptual understanding based on the level of reasoning assessment.

The system's method contains an adaptive component that adjusts itself not only to the student's answer but also reasoning level ability. For example, a student must get the correct answer and the required reasoning method on an item of intermediate difficulty, to be presented with a more difficult question next. The system's methods can be used as a method for reporting on individual and/or whole classroom metrics.

When teachers use systematic progress monitoring to track their students' progress, they are better able to identify students in need of additional or different forms of instruction, they design stronger instructional programs, and their students achieve better.

The system's methods are able to track students' progress over time. As students are assessed over a longer time span, the teacher can see individual and aggregate progress.

A further step in the formative assessment cycle is timely, informational feedback that helps students understand how they measure up to learning goals, and what they need to do to reach them.

Formative assessment is most effective when combined with timely informational feedback. Meta-analysis of studies on formative assessment found an effect size on standardized tests of between 0.4 and 0.7, larger than most known educational interventions.

Further, feedback was found to be most beneficial for students when it focuses on particular qualities of a student's work in relation to established criteria, identifies strengths and weaknesses, and provides guidance about what to do to improve. Similarly, although feedback has a significant impact on student learning, the quality and nature of feedback can have differential effects; for example, information related to student activities and containing information on how students can improve their performance.

To improve student learning, for example, like (but differently unique) teachers can give feedback on correct/incorrect answer by pointing to calculation errors, the teacher can give feedback on the worked item to nudge the student to use a different reasoning methods. This can be in multiple forms such as written hints, other worked examples, giving a lesson.

The system intelligently assesses student responses to test questions. Grading and analyzing students' competencies (in disciplines such as mathematics) and tracking their progress over time is a labor-intensive and error-prone task for teachers. In addition, what is often important to know is not merely whether the student answered correctly, but how the answer was obtained, i.e. which method(s) of reasoning the student used. The system is able to analyze students' work, interpret and classify their reasoning methods, and recommend the most appropriate learning interventions.

An aspect of the system is the ability of the system to interpret and classify students' reasoning by analyzing their scratch work (digital strokes in the user interface scratch pad area) and explanations (text inputs prompting students to justify their answer).

Another aspect is that the system includes scoring rubrics and intelligent technology to allow the system to provide meaningful categorization of student's method(s) of reasoning (e.g. “Student adds fractions by converting them to decimals”) and the appropriate recommendations (e.g. “Student needs to learn to convert fractions to a common denominator”).

These and other aspects and advantages of the invention will become apparent from the following detailed description which describes by way of example the features of the invention.

### BRIEF DESCRIPTION OF THE DRAWINGS

FIG. 1 is a screen view of methods for solving a problem in accordance with an embodiment of the invention;

FIG. 2 is a representational view of mapping methods to strands and standards in accordance with an embodiment of the invention;

FIG. 3 is a representational overview of system architecture in accordance with an embodiment of the invention;

FIG. 4 is a student's screen view in accordance with an embodiment of the invention;

FIG. 5 is a student's scratch area view in accordance with an embodiment of the invention;

FIG. 6 is a representational view of an analysis component in accordance with an embodiment of the invention;

FIG. 7 is a digital representational view of a stroke in accordance with an embodiment of the invention;

FIG. 8 is an exemplary view of stroke clustering in accordance with an embodiment of the invention;

FIG. 9 is an exemplary view of optical character recognition in accordance with an embodiment of the invention;

FIG. 10 is an exemplary view of features computed by the system and method in accordance with an embodiment of the invention;

FIG. 11 is an exemplary view of rules used in rubrics in accordance with an embodiment of the invention;

FIG. 12 is an exemplary view of rules that map features to methods and levels in accordance with an embodiment of the invention;

### DETAILED DESCRIPTION OF THE PREFERRED EMBODIMENTS

The computerized intelligent assessment system and method intelligently assesses performance and learning of a task related to a concept, to enable generating conceptual understanding of the concept based on the assessment The system generates evidence as an indicator of reasoning about the task related to the concept. The system includes a rubric for analyzing a student's work in answering the questions and comparing to relevant standards for generating levels of reasoning observed in the observation program. The system still further reports and keeps track of student's scores in the current and all previous tasks observed, as well as additional data about the school, class, student, tasks and any other relevant information, and determines whether the student's response has or has not met the standard corresponding to the task.)

The system and method observe evidence including work and lack of work as an indicator of learning of the task related to the concept. The system generates a level of reasoning assessment of the performance and learning of the task, and utilizing a pattern of recognition to generate a performance profile to determine the next task in order to achieve conceptual understanding based on the level of reasoning assessment. The system includes an adaptive program, which is based on scores and any other data observed in the report program to generate the next appropriate task to be administered.

Generally, for example, as referred to herein, a subject comprises a teaching subject, including traditional subjects such as, for example, all mathematics, all science, all language, including composition, English, including grammar, spelling, and content development. Further, a subject domain includes patterns, geometry, numbers, operations, and the like, and a strand includes a unit within the subject-domain.

The computerized intelligent assessment system and method can administer digital items. It can analyze all types of student work, whether done digitally using a mouse, finger or stylist, tablet computer, or touch screen for digital strokes.

The system has a front end and a back end. The front-end can include a set of Web pages and supporting logic (e.g. HTML5, JavaScript, CSS) that enable the user to interact with the system. For example, students can log in, answer test questions, see their results. Teachers can log in, see their students' work with corresponding analysis and recommendations, and give students feedback.

The back end supports the functioning of the user interface, with the following functionality, and more: maintaining a database of student/teacher accounts and past activity; maintaining a database of questions and corresponding metadata (e.g. question difficulty); analyzing student's responses, classifying method(s) of reasoning, generating recommendations; selecting the next question to present to the student based on their past activity and performance; aggregating information about students' performance for the teacher.

A typical case would use the system in the classroom, computer lab or at home as homework, but does not have to be limited to these environments. The system's methods can be used in a report program, wherein any item can be used to collect student responses. In the report program, items can be administered singularly, and items can also be administered as item sets. Teachers can, through the system and method, use current curriculums items in order that they appear on homework, practice problems, quizzes, tests, or the like, or they can order and administer the items in order of item level difficulty and next appropriate item based on student response to prior items analyses. The report program may include an adaptive program

Item sets can be considered a set of items which has a predetermined number of items that get administered regardless of student responses; for example, item sets can include, but are not limited to, homework, practice problems, quizzes, tests, and the like.

In an example of use of the system and method, each student would have an individually created account, which saves their past history and performance statistics (correct/incorrect answers, partial credit scores, reasoning methods and reasoning levels)

After a student logs in, the system would display the next problems (“item”) that is most appropriate given the standard or topic specified by the administrator of the program (for example, but not limited to teacher, parent, special education teacher, etc.), and student's past performance on the relevant standard(s). Items can consist of: the problem question and corresponding illustration; the student's answer (a short text field or a multiple choice selection); the student's explanation (long text field); the student's scratch work (freehand digital ink annotations)

In the next step, the students' response work is captured, analyzed and interpreted.

The system is capable of interpreting and classifying students' reasoning by analyzing their scratch work (digital or pen ink strokes in the graphical scratch pad area) and explanations (free-text writing inputs prompting students to justify their answer). The system and method enable providing meaningful categorization of student's method(s) of reasoning (e.g. “Student adds fractions by converting them to decimals”) and the appropriate recommendations (e.g. “Student needs to learn to add numerators of fractions with common denominators”).

In a further step, stroke clustering analyzes the digital pen strokes in the scratch area, clusters them into logically coherent clusters, and classifies them as numeric expressions or drawings.

In a still further step, OCR (Optical Character Recognition) recognizes text and numeric expressions in digital strokes.

Also, in a further step, the rubrics component uses the features computed in the previous step, to determine which method(s) of reasoning were used by the student. Students work can contain multiple reasoning methods and multiple levels of reasoning. For example, analyzing the same student's work, the student' s explanation contains text indicators, such as contains variables, thus using the rubric the student not only used a reasoning method in reasoning level 0 (e.g. “uses a table to extend the pattern”), and also used the reasoning method “uses a formula with variable” which is reasoning level 3.

The system and method maps features in the student's work to methods of reasoning and/or levels of reasoning,

In another further step, an adaptive module takes into consideration: student's answer (correct/incorrect) method(s) of reasoning used by the student in the current and previous question(s) and other metadata about question(s) and relevant standards, to compute the student's score for the current question and update the student's performance profile.

Another example would be exit-tickets. Exit-tickets consist of one item that is sent out at the end of a class period. All students get the same item and that item assesses what was covered in the lesson that class period. Then the teacher would score the items using the system's methods before the next class period to adjust the lesson plan.

For example an additional step would be a method for labeling item information, which could consist of but not be limited to information as item type, item difficulty, item format difficulty, standard, or the like.

In a still further step, the subsequent item is to be presented. In an example of this step, after the system analyzes students' work, it might do one of the following: if the student got the correct answer and demonstrated the appropriate level of reasoning, the system presents the next item of the same standard but more advanced difficulty; if the student got the answer incorrectly, but used the right level of reasoning, the system would prompt the student to check their calculations on the same item; if the student did not demonstrate the right level of reasoning, the system may present an easier item of the same standard, and/or give the student a hint (e.g. “try converting fractions to a common denominator”) and/or present a personalized intervention (e.g. the given item solved with the proper method or a short video on how to convert to common denominators); if the student got the correct answer, but did not sufficiently justify it, the system would prompt the student to explain their reasoning.

The adaptive module also could generate the following information to be presented to the student on the next screen: feedback on their answer (e.g. “Your answer was correct!”); hints (e.g. “Check your calculation” or “Try converting to decimals”); interventions (showing a video or read a lesson plan describing a particular method of fraction multiplication)

The system and method enable the teacher to observe students' performance. In addition to displaying students' work and whether they got the correct answer, the system is able to show the method(s) of reasoning used by the student and the method(s) required by the corresponding standard.

Thus, the teacher can easily identify students that are struggling with a particular concept or not grasping a particular method of solving a problem. Based on that information, she/he may either adjust her subsequent lesson plans (whole groups) or intervene with a small group of students who need help with a targeted skill.

The systems rubric can provide the teacher conceptual scaffolding on how to teach the necessary skills to students. For example, when teaching the following standard: “Apply and extend previous understandings of multiplication to multiply a fraction by a whole number”, a teacher could identify that the student used an informal method to solve the problem: “It takes ⅙ of a stick of butter to make one brownie. Ryan wants to make 20 brownies. How many sticks of butter will Ryan need to make twenty brownies?”.

Here, the teacher could build on the student's visual representations by demonstrating that because each stick of butter has 6 sections, each section of butter equals ⅙. The numerator is the fractional part or 1 and the denominator is the whole or 6, thus the fractional part of one section to the whole is ⅙, the fractional part of two sections of the whole stick is 2/6, and so on thus a more progressive understanding is the pre-formal strategy of adding ⅙ twenty times. The formal method would be to multiply ⅙×20.

Because each student's work is digitally saved, it can be later shown on an interactive whiteboard (or using screen mirroring), as a starting point for an in-class discussion about different methods to solve a given problem.

The system also aggregates students who reason similarly into groups so the teacher can create small group discussions to work on improving the students' reasoning by building on the groups' current reasoning level. It would look much like an elementary teacher's classroom that would bring back a small reading group where all students are at the same level and they work at the semicircle reading table on the skills they need.

Generally, for example, as referred to herein, a subject comprises a teaching subject, including traditional subjects such as, for example, all mathematics, all science, all language, including composition, English including grammar, spelling, and content development. Further, a subject domain includes patterns, geometry, numbers, operations and the like, and a strand includes a unit within the subject-domain.

The rubric was developed from the notion that teachers who desire to teach for student's understanding recognize the need for a broader perspective of classroom assessment to develop student reasoning, not just knowledge. The rubric places students on a continuum of concepts in context within a patterns strand of a subject. It offers teachers a way to interpret student's thinking in a subject. The rubric describes the growth in student's understanding of concepts in a subject, for example, at the middle school level.

The rubric places students' cognitive ability on a continuum of learning which ranges from informal to formal reasoning. It meets the need for teachers' deep understanding of students' reasoning to improve student achievement and better teachers. Teachers need to be able to teach different strategies when teaching to solve problems so they will be reaching all learners. Standardized testing may use this rubric for their constructed responses for improved scoring.

The system and method enable generating conceptual understanding of the concept based on the assessment. The systems evidence as an assessment of the reasoning about the concept as an indicator of the learning of the task related to the concept. It further generates a level of reasoning assessment of the performance and learning of the task, and utilizing a pattern of recognition to generate a performance profile to determine the next task in order to achieve conceptual understanding based on the level of reasoning assessment.

The system and method enable evidence, including work and lack of work, to be as an indicator of learning of the task related to the concept. They may generate multiple levels of reasoning assessment of the performance and learning of the task. The performance profile includes all levels of reasoning utilized for the current and previous tasks, and based on the performance profile the patterns of recognition therein may be used to generate the next task in order to achieve conceptual understanding and raise the level of reasoning. Work includes answers that are correct and incorrect, explanations which comprise text, and student's graphical scratch work which comprises show your work, and show your work comprises strokes. Answers, explanations, and graphical scratch work comprise multiple text expressions and stroke expressions which comprises multiple features, which features comprise mathematical symbols and the number system, and mathematical symbols include, for example equality, inequality, plus, minus, times, division, power, square root, percent, decimal, and variables.

The level of reasoning assessment ranges from informal to formal. The levels of reasoning include a first level comprising an informal manipulative representational level, wherein only patterns are seen in a contextual sense, and there is reliance on a representation of the growth pattern. The levels of reasoning include a second level comprising an informal-formal situation-specific concrete imagery understanding level, wherein rules and definitions are utilized as strategies, no longer needing a representation to understand the growth pattern The levels of reasoning include a third level comprising a formal-informal circumstantial understanding level, wherein the growth pattern is seen, understood, and generalized such that the understanding about growth is independent of the situation-specific concrete imagery. The levels of reasoning include a fourth level comprising a formal abstract reasoning level, wherein the interpretation program is generalized across situations and thus becomes an entity in itself, reasoning encompasses all levels, and understanding of patterns is abstract, and growth patterns can be seen, understood, and generalized and represented with conventional symbols. The observation program and the interpretation program are programs for the teaching of a subject. The teaching subject may comprise mathematics.

The system and method enable assessment of performance and learning of a task related to a concept enables generating conceptual understanding of the concept based on the assessment, to generate conceptual understanding of the concept based on the assessment, in a system which includes a rubric module for assessment of performance and learning of a task related to a concept, and to enable generating conceptual understanding of the concept based on the assessment The method includes generating evidence as an assessment of the reasoning about the concept as an indicator of the learning of the task related to the concept, in the observation program. The method further includes generating a level of reasoning assessment of the performance and learning of the task, and utilizing a pattern of recognition to generate a performance profile to determine the next task in order to achieve conceptual understanding based on the level of reasoning assessment, in an interpretation program, linked to the indicator in the observation program.

The system includes cognition information generated by all system users, enabling it to continually collect, organize, make sense of, and use the cognition information to generate intelligent modification of an initial core hypothesis regarding reasoning about the task to define conceptual understanding of the task. The system continuously collects information of different types of levels of reasoning achieved and how information is processed to generate new learning trajectories and reasoning levels about concepts to be efficient in learning and reasoning. The system compiles the learning and reasoning information, and uses the compiled information to create conceptual tasks based on the observation and interpretation programs that work with different cognitive styles.

The idea of progress is fundamental to all teaching and learning. This notion becomes evident when teachers use words such as “better,” “deeper,” “higher” and “more” to describe students as becoming better in the subject field, developing deeper understandings, gaining higher order skills, and solving more difficult subject problems. A feature of the system is that it allows students to solve the items through different strategies.

Thus, students' decisions regarding particular subject concepts can be described as different levels of reasoning. The reasoning rubric program defines these different levels of reasoning as ranges of progressive formulization from informal to formal reasoning of concepts.

Students' decisions regarding particular concepts can be described as different stages (levels) of reasoning. The construct map defines these different levels of reasoning as ranges of progressive formulization from informal to formal knowledge of concepts in context.

To be in compliance with the assessment principles, whereby assessment methods enable students to show what they know rather than what they do not know, responses are not based solely on correctness or knowledge. Instead, scoring is also based on whether the respondent's reasoning is at the manipulative level, rote level, circumstantial level or symbolic level. In addition to defining student reasoning at each level of the continuum, the strategies which are used by the students are defined as descriptors of reasoning in the context of patterns and regularities. They can be distinguished by students' understanding of “growth” in patterns.

For instance, reasoning at the manipulative level, students can only see a pattern in a contextual sense, thus they rely on a representation of the pattern to see the growth. At the next level, students' understanding of patterns becomes concrete. At this level, they use rules and definitions as strategies to reason about the growth. They no longer need a representation to understand the growth pattern. Then, at the circumstantial level, students' understanding about growth is independent of the situation-specific (concrete) imagery. The modeling activity (reasoning) at this level shows that the student not only sees and understand s the growth, but they can also generalize about the pattern. At the highest level of reasoning, the model first developed by the student is generalized across situations and thus becomes an entity in itself. Reasoning at this level encompasses all levels. Students' understanding of patterns is now abstract. They can see, understand, generalize and represent growth patterns with conventional symbols.

The system and method are iterative of systemic formative assessment. Since there are limited assessment materials available to support teacher's ability to elicit and make sense of student's reasoning, they provide an initial framework for developing diagnostic formative assessments which are valid and reliable in teaching disciplines.

The system's item-specific rubrics help teachers “unpack” standards into smaller, more measurable learning goals, so teachers can see what students know and where they need to be to meet learning goals and make those goals explicit to students. Then the different reasoning methods that act as stepwise learning goals within the range of reasoning levels become the foundation in supporting teachers to take instructional action to help students progress along the continuum to meet overall learning goals.

These different strategies used to solve the problem can be considered different reasoning methods that range in degree of sophistication from informal to pre-formal to formal

Further, these different reasoning methods can be categorized as different of levels of reasoning, level 0, level 1, level 2, consecutively and the formal reasoning method, converting to common denominators is the recommended reasoning method that meets the learning goal.

The system and method focus on the measurement of student's reasoning, not just knowledge, as an assessment tool used for instructional design and teaching. Learning progressions developed by curriculums show the cognitive developmental progress of student learning, including the richness and correctness of mathematical content and the way material should be instructed to students. They quantify typical student mathematical reasoning for classroom teachers.

Progressive formulization is a teaching approach that begins with student's informal strategies and knowledge which develops into pre-formal methods that are still connected with concrete experiences, strategies and models. Then, through guided reinvention, as described above, the pre-formal models and strategies progressively develop into abstract and formal mathematical procedures, concepts, and insights. Supporters of this reformed teaching approach recognize that many teachers tend to skip informal mathematics and go straight to teaching formal mathematics. By teaching only formal mathematics, teachers are discouraging the knowledge of students' understanding of concepts in context which causes students' understanding of knowledge and skills to suffer. Thus, teachers who support learning with understanding need to sequence their instructional approach as progressive formalization.

The curriculum suggests that teaching informal mathematics will make students aware of mathematical phenomena in their surroundings. Students bring to school informal or intuitive knowledge of mathematics that can serve as a basis for developing much of the formal mathematics of the primary school curriculum. Thus, without skipping informal mathematics, students can draw connections from intuitive prior knowledge allowing them to piece together practical solutions to a wider range of more formal problems (i.e., progressive formulization).

The system and method may include a narrative, and the assessment system may include pre/post-tests that will assess student's reasoning for key concepts, often assessed on standardized tests, for example, in every mathematics subject domain. Items design may include multiple tasks per assessment. Tasks are constructed in response to questions which range in different levels of difficulty. Teachers will administer the formative assessments immediately prior to and after the unit of study. Teachers may be able to monitor the progress of their students throughout the year and track individual students across grade levels. These assessments may be the basis for benchmarks which may be helpful to teachers in their classrooms, and may also be an important part of the overall evaluation of the reasoning rubric cube systematic assessment system.

Formative assessment is about getting informative feedback and using it to guide future teaching and learning. The way teachers handle formative assessment is an important challenge, particularly since its effective use may be orthogonal to their normal view of assessment. In most countries, both teachers and system leadership act as though formative assessment is having summative tests more often.

The grading of tasks based on the rubric associated with each key concept or assessment may be related to defining overall reasoning levels for students. The rubric may follow a logical rule for converting rubric scores into grades, such as A's, B's, Pass/Fail, or the like. It may be used by teachers to indicate the next steps in the progress of students.

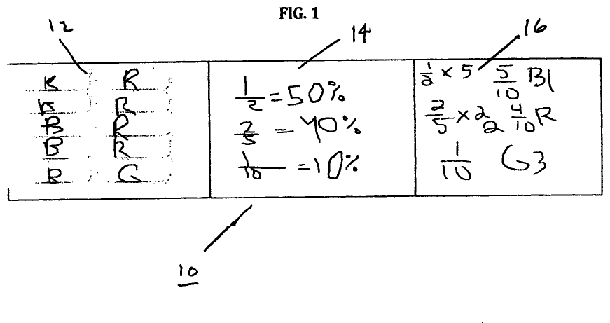

As further described and as shown in FIGS. 1-13, in a preferred embodiment of the invention, a computerized intelligent assessment system 10 is adapted for use in intelligently assessing student responses to test questions. The system includes a user interface work area for student responses to test questions. The system further includes a grading and analyzing software module for grading and analyzing student competency, including a response and method determining software module for determining correctness of the student response and for determining the method by which the response was obtained.

In a subject area such as mathematics, in accordance with a preferred embodiment of the invention, for example, most Common Core Mathematics Standards expect students to use particular reasoning methods. For example: 4.NF.A.2 “Compare two fractions with different numerators and different denominators, e.g., by creating common denominators or numerators, or by comparing a benchmark fraction such as ½.”

In another example of a test question of a mathematics problem, Giselle has a set of 10 bookmarks made up of three different colors: ½ blue, ⅖ red, 1/10 green. Type each fraction above in the order from least to greatest. This type of problem can be solve in a number of ways, These methods for solving problems in test responses range in degree of sophistication, from informal to pre-formal to formal, as shown in FIG. 1 for example, including informal 12 using the drawing, pre-formal 14 converting to percent, and formal 16 converting to a common denominator.

The system is able to not only understand whether the students' answer is correct or incorrect, but to actually diagnose which, of a number of strategies, the student used to solve the problem. In order to do that, the system must understand the possible strategies (here known as “subcategories”) for each type of problem (here known as “strand”). A strand corresponds to one or more CommonCore standards, for example in 4.NF.A.2 above, for comparing two fractions.

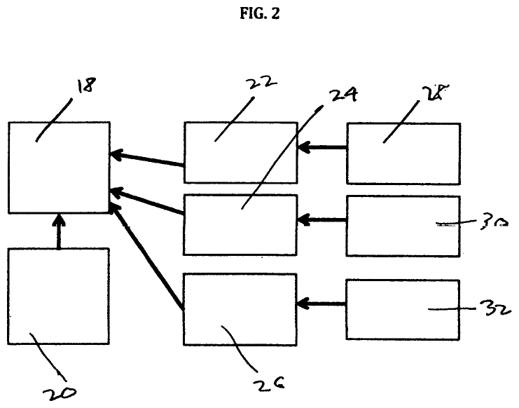

Thus the system has a model of each supported strand, including methods that can be used in solving problems of that strand, reasoning methods to which they correspond, and levels for each method. As seen in FIG. 2 for example, these methods include a strand 18 for comparing two fractions, and a standard 20 of 4.NF.A.2. Methods include a method 22 of using drawings, a method 24 of converting to percentages, and a method 26 of converting to common denominators. Levels include a level 28 for pre-formal, a level 30 for informal, and a level 32 for formal.

The system must therefore be able to take the student's response to a problem consisting of answer, written explanation of how they solved the problem, and digital scratch writing instrument marks (“strokes”)—and analyze it to figure out which method the student used to solve it. In order to do that, the system needs to be trained on how to categorize a student's answer. For example, if student's work (explanation or strokes), contains a percent sign (“%”), this serves as evidence that the student used the “convert to percent” strategy.

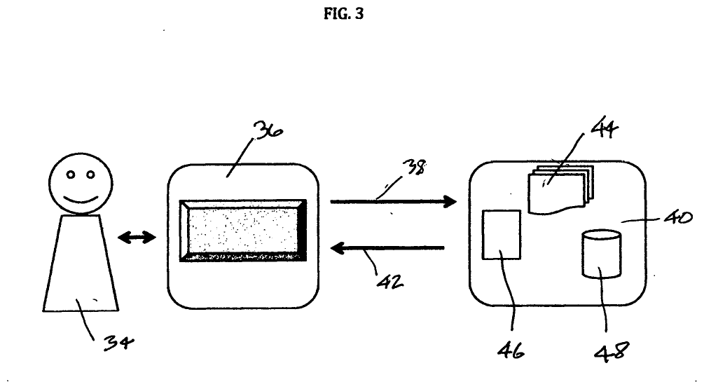

The system includes a front end and back end. The front end is a set of Web pages that constitute the user interface (e.g. presenting test questions to the student, capturing their responses). The back end is a Web server that serves content to the front end, stores students' responses in the database and analyzes students' work. As illustrated in FIG. 3, there are shown a student 34, a front end 36, student's responses 38, back end 40, system responses 42 at the back end 40 including next question, analysis results, and recommendations, and the back end 40 including questions 44, analysis logic 46, and database 48.

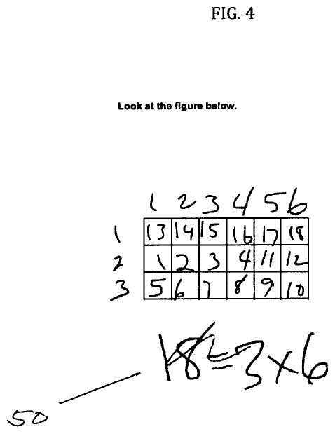

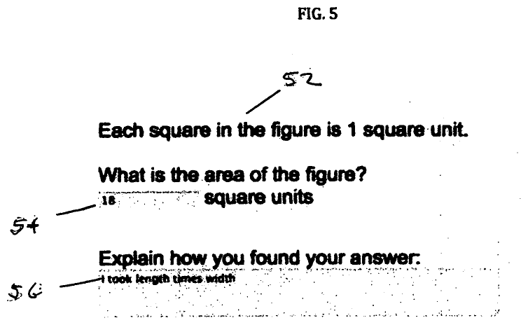

The front-end is composed of a set of Web pages and supporting logic (e.g. HTML5, JavaScript, CSS) that enable the user to interact with the system. For example, students can log in, answer test questions, see their results. Teachers can log in, see their students' work with corresponding analysis and recommendations, give students feedback. In FIG. 4 is shown a student's scratch area 50. FIG. 5 shows an example of the student's view, displaying a test question 52, a student's answer 54, and a student's explanation 56.

The back end of the system supports the functioning of the user interface, with functionality, including: maintaining a database of student/teacher accounts and past activity; maintaining a database of questions and corresponding metadata (e.g. question difficulty); analyzing student's responses, classifying method(s) of reasoning, generating recommendations; selecting the next question to present to the student based on their past activity and performance; aggregating information about students' performance for the teacher.

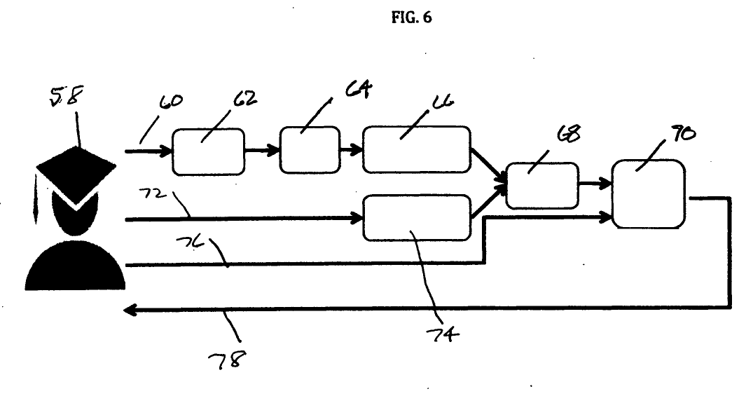

The analysis component in the system is responsible for analyzing the students' work and determining the method of reasoning used by the student, as well as appropriate recommendations. In FIG. 6, there is illustrated a user 58, inputs to the system, and outputs from the system. The inputs to the system include strokes 60, including stroke clustering 62, optical character recognition 64, and stroke feature extraction 66, input into a rubric 68 and adaptive scoring 70. The inputs also include text 72, including text feature extraction 74, also combined with strokes 60 into rubric 68 and adaptive scoring 70. Also input into the system is an answer 76, input into adaptive scoring 70. The outputs 78 from the system include feedback, intervention, and next question.

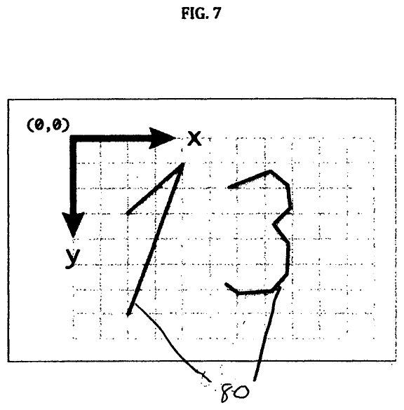

Student's strokes are encoded as a sequence of line segments, in a coordinate system (corresponding to the coordinate system of the computer screen). As seen in FIG. 7, there are digital representations 80 of each stroke, for example, consisting of a sequence of (x,y) coordinates. In the drawing in FIG. 7 the number “1” is a single stroke that has 2 line segments, and can be represented as a sequence ((2,2), (4,1), (2,7))

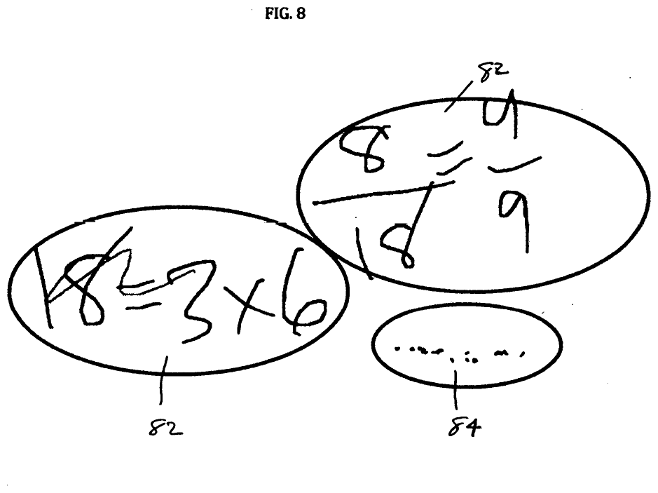

Stroke clustering analyzes the digital pen strokes in the scratch area, clusters them into logically coherent clusters, and classifies them as numeric expressions or drawings. In FIG. 8, the ovals show an example of clustering of the strokes into three clusters, and corresponding classification of each cluster. as numeric 82 and drawing 84.

The clustering software module assigns each stroke in the student's answer to a particular cluster, based on the stroke's geometrical features. Once the cluster membership is computed, another software module decides the type of each cluster for example numeri, drawing, and text)

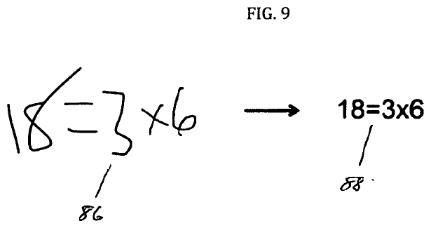

Optical Character Recognition, as shown for example in FIG. 9, recognizes text and numeric expressions 86 in digital strokes 88. FIG. 9 shows an example of a recognized graphical expression.

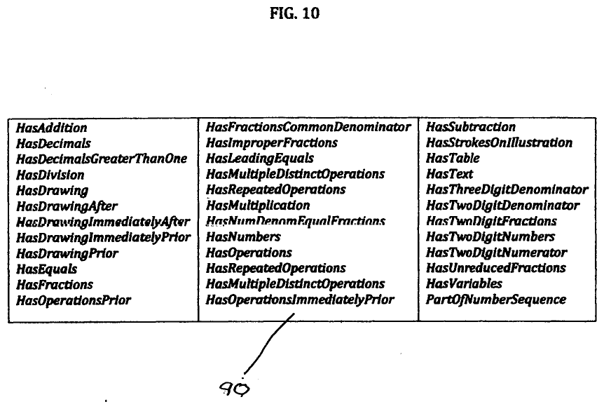

Stroke and Text Feature Extraction takes the logical representation of text or graphical expressions and computes features that are useful for the following step (“Rubrics”). For example, in FIG. 10, examples of features 90 computed by the system include: HasVariables: expression contains variables (e.g. “2x=1”); HasDecimals: expression contains decimals (e.g. “2.5+1”); HasUnreducedFractions: expression contains unreduced fractions.

Each feature value is computed using a software module that works either on typed text or digital strokes. For example, the software module for computing HasFractions in text, will look for a division sign between two numbers (e.g. “I added ½ to x”) or a lexical expression of a fraction (“One forth of bookmarks are red”). This can be implemented in “regular expressions” or a text pattern-matching software module.

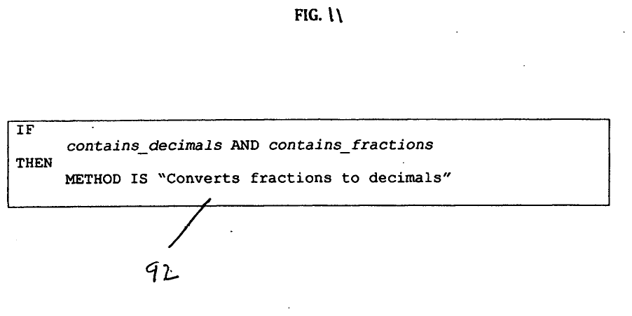

The rubrics component uses the features computed in the stroke and text feature extraction to determine which method(s) of reasoning were used by the student. A combination of learning classification and explicit rules is used to map features in the student's work methods of reasoning. For example, as shown in FIG. 11, a rule 92 used in rubrics can capture the logic.

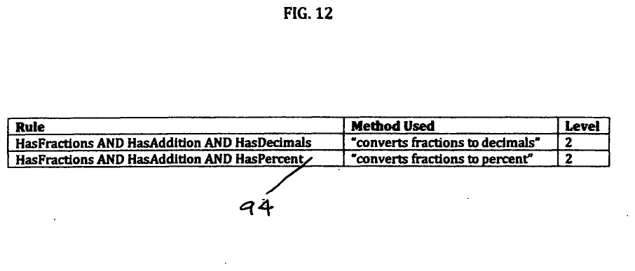

In FIG. 12 is shown mapping rules 94 consisting of a Boolean expression over features mapping to the resulting Method (and corresponding level. The feature extraction component of the system first computes the feature values (e.g. HasFractions) over the student answers. Then the rubric component evaluates all of the rules in sequence to determine the method. The rule evaluation may be performed with a statistical learning approach, where the method is determined using a learning software module on the basis of feature values.

The adaptive scoring software module takes into consideration: student's answer (correct/incorrect); method(s) of reasoning used by the student in the current and previous question(s); other metadata about question(s) and relevant standards, to compute student's score for the current question and update the student's performance profile. The adaptive scoring software module also generates information to be presented to the student on the next screen: feedback on their answer (e.g. “Your answer was correct!”); Hints (e.g. “Check your calculation” or “Try converting to decimals”); Interventions (showing a video describing a particular method of fraction multiplication); The subsequent question to be presented.

An adaptive scoring software module includes a set of rules to determine the output (what the student sees next) based on the input (student's work on the last and previous question). It can also be implemented using learning software modules that learn the optimal sequence of outputs over time, based on the objective function of improving students' performance on a given standard.

In a method of computerized intelligent assessing of responses to questions as work entries, in the system of the preferred embodiments of the invention, is also included, among other steps, determining reasoning methods in problem solving responses for degrees of work sophistication, in the reasoning methods module of the system. Further included in the method is determining problem-solving work response strategies of subcategories for problem-type strands in the reasoning methods module, and understanding work response correctness, and diagnosing problem-solving work response strategies of subcategories for problem-type strands, in the system response correctness and diagnosing module.

The method also includes, among other steps, presenting questions and capturing work responses including in a system front end module, including presenting the questions and capturing work responses in a user interface. Further included in the method is analyzing the work responses, determining the reasoning method, and generating recommendations, in the system analysis module. The method further includes analyzing digital strokes in the scratch area, clustering and assigning strokes to logically coherent clusters, and classifying a cluster type as numeric expressions or drawings, in a stroke clustering module.

While the particular computerized intelligent assessment system and method, as described above and shown in the Figures, are fully capable of obtaining the objects and providing the advantages as stated herein, it is to be understood that it is merely illustrative of the presently preferred exemplary embodiment of the invention, and that no limitations are intended to the details of construction or design shown herein other than as described in the appended claims.

I claim:

1. A computerized intelligent assessment system for use in intelligently assessing responses to questions as work entries, comprising:
a reasoning methods module for determining reasoning methods in problem solving responses for degrees of work sophistication.

2. A system as in claim 1, wherein the system further includes reasoning methods module further includes problem-solving work response strategies of subcategories for problem-type strands, and wherein the system further includes a response correctness and diagnosing module for understanding work response correctness and for diagnosing the problem-solving work response strategies of subcategories for the problem-type strands.

3. A system as in claim 1, wherein the system further includes questions, and a reasoning methods module further includes a system front end module, including a user interface for presenting the questions and capturing work responses.

4. A system as in claim 1, wherein the reasoning methods module further includes an analysis module for analyzing the work responses, determining the reasoning method, and generating recommendations.

5. A system as in claim 1, wherein work entries comprise digital strokes entered in a scratch area, and wherein the reasoning methods module further includes a stroke clustering module for analyzing digital strokes in the scratch area, clustering and assigning strokes to logically coherent clusters, and classifying a cluster type as numeric expressions or drawings.

6. A system as in claim 3, wherein the reasoning methods module further includes a system back end module, including a server for serving content to the front end, wherein the system back end module stores work responses in a database, and analyzes the responses and supports the functionality of the front end.

7. A system as in claim 6, further comprising an optical character recognition module for recognizing text and numeric expressions in digital strokes.

8. A system as in claim 6, further comprising a stroke feature extraction and text feature extraction module for determining work features from logical representation of text or graphical expressions.

9. A system as in claim 8, further comprising a rubrics module for determining the method of reasoning from features.

10. A system as in claim 8, further comprising a mapping module for mapping the features to the methods of reasoning.

11. A system as in claim 9, further comprising a feature extraction module computing feature values over responses, which includes a rubric component for evaluating sequence rules to determine the method, and for determining the method based on the feature values.

12. A system as in claim 8, wherein the system further includes standards, and further comprises an adaptive scoring software module for considering the response correctness and incorrectness, the reasoning method used in current and previous questions, and data about question and standards.

13. A system as in claim 12, wherein the system further includes a performance profile, and wherein the adaptive scoring software module further includes computing the score for the current question and updating the performance profile.

14. A system as in claim 12, wherein the system further includes answer feedback, hints, interventions, and subsequent questions, and wherein the adaptive scoring software module further includes generating information to be presented in the scratch area, and generating answer feedback, hints, interventions, and subsequent questions to be presented.

15. A system as in claim 12, wherein the adaptive scoring software module further includes a set of rules to determine the output of what is to be seen next based on the input of work on the last and previous questions, and learning the optimal sequence of outputs over time based on the objective function of improving performance on a given standard.

16. A method of computerized intelligent assessing of responses to questions as work entries, comprising:
determining reasoning methods in problem solving responses for degrees of work sophistication, in a reasoning methods module.

17. A method as in claim 16, further comprising determining problem-solving work response strategies of subcategories for problem-type strands in a reasoning methods module, and wherein the system further includes understanding work response correctness and diagnosing problem-solving work response strategies of subcategories for problem-type strands in a response correctness and diagnosing module.

18. A method as in claim 16, further comprising presenting questions and capturing work responses in a system front end module including presenting the questions and capturing work responses in a user interface.

19. A method as in claim 16, further comprising analyzing the work responses, determining the reasoning method, and generating recommendations, in an analysis module.

20. A method as in claim 16, further comprising analyzing digital strokes in the scratch area, clustering and assigning strokes to logically coherent clusters, and classifying a cluster type as numeric expressions or drawings, in a stroke clustering module.
